(19) United States
(12) Patent Application Publication
(10) Pub. No.: US 2011/0031418 A1
(43) Pub. Date: Feb. 10, 2011

(54) OPTICAL SENSOR MEASUREMENT AND CROSSTALK EVALUATION

(75) Inventors: Igor Shcherback, Beer-Sheva (IL); Orly Yadid-Pecht, Calgary (CA)

Correspondence Address: MARTIN D. MOYNIHAN d/b/a PRTSI, INC., P.O. BOX 16446, ARLINGTON, VA, 22215, US

(73) Assignee: Ben Gurion Univesity of the Negev Research and Development Authority, Beer-Shev (IL)

(21) Appl. No.: 12/740,381

(22) PCT Filed: Oct. 30, 2008
(86) PCT No.: PCT/IL08/01429

§ 371 Date: Nov. 1, 2010

Related U.S. Application Data
(60) Provisional application No. 61/001,061, filed on Oct. 31, 2007.

(51) Int. Cl. G01N 21/86

(52) U.S. Cl. 250/559.29

(57) ABSTRACT

An apparatus for the measurement of optical sensor performance includes a light emitter, a focuser and a controller. The optical sensor comprises a plurality of pixels, which may be arranged as a pixel array. The light emitter projects a light spot onto the sensor. The focuser focuses the light spot onto a specified portion of the sensor in accordance with a control signal. The controller analyzes an output signal of the optical sensor, and generates the control signal to an accuracy substantially confining the light spot to a single pixel in accordance with the analysis.

### RELATED APPLICATIONS

This application claims the benefit of U.S. Provisional Patent Application No. 61/001,061, filed Oct. 31, 2007, which is herein incorporated in its entirety by reference.

### FIELD AND BACKGROUND OF THE INVENTION

The present invention, in some embodiments thereof, relates to the measurement of an optical sensor output signal by accurately focusing a light spot on the optical sensor, and, more particularly, but not exclusively, to the analysis of the measured optical sensor performance data for pixel crosstalk evaluation.

The rising demand for portable cheap and compact image sensory devices has resulted in a continuous growth in requirements for enhanced sensor performance and improved image quality. Currently, the resolution of an image sensor is characterized by its absolute pixel count. However, the sensor resolution may be degraded by the global distortion between pixels due to information leakage from a given pixel to its surroundings and to the crosstalk of photonic (e.g., optical, chromatic) and/or electronic sources. These effects degrade the spatial frequency, reduce overall sensitivity, cause poor color separation and lead to additional noise after the color correction procedure. Therefore, the true effective image resolution might be much below the nominal, represented by the pixel number in the array. The loss of photocarriers due to crosstalk typically translates directly to loss in image contrast.

Many attempts have been made to characterize and reduce crosstalk in image sensors, either by means of technology or by design improvements see T. H. Hsu et al., “Light guide for pixel crosstalk improvement in deep submicron CMOS image sensor”, IEEE Electron Device Letters, vol. 25, no. 1, pp. 22-24, January 2004; A. Getman, T. Uvarov, Y. Han, B. Kim, J C. Ahn, Y H. Lee, “Crosstalk, Color Tint and Shading Correction for Small Pixel Size Image Sensor”, 2007 Int. Image Sensor Workshop, June 2007; J. S. Lee, J. Shah, M. E. Jernigan, R. I. Hornsey, “Characterization and deblurring of lateral crosstalk in CMOS image sensors”, IEEE Trans. Electron Devices, vol. 50, pp. 2361-2368, January 2003; G. Agranov, V. Berezin, R. Tsai, “Crosstalk and microlens study in a color CMOS image sensor”, IEEE Trans. Electron Devices, vol. 50, pp. 4-11, January 2003; and H. Mutoh, “3-D optical and electrical simulation for CMOS image sensors”, IEEE Trans. Electron Devices, vol. 50, pp. 19-25, January 2003].

In order to mitigate the effects of crosstalk, some image sensor manufacturers have attempted to position the color filter array (CFA) as close as possible to the active light sensitive areas of the pixels, to use an accurately configured and positioned microlens array (MLA), or other optical or mechanical means. Layout of the pixels in the array, barriers between pixels, color disparity correction after color interpolation of the raw pixel outputs, etc., might be useful methods in reducing crosstalk and associated color disparity for an image sensor. Disadvantages of such methods include increased image sensor cost, increased power consumption, difficulties in sensor fabrication and other unwanted effects.

Other ways of evaluating the signal/crosstalk cross-responsivity distribution include: using special test-chip structures covered by metal shields with particularly spaced openings; modeling using numerical approximation methods; and the utilization of special test-patterns with subsequent image processing. Currently, However, the shield-openings technique requires the physical fabrication of the especially designed test-chip (which means additional expenses), and is also subject to the inherent errors due to diffraction effects, especially considering modern technologies with extremely small pixel sizes. The modeling and use of special test pattern approaches do not approach the precision needed for the micrometer-order pitches of currently available sensors. Additionally, the algorithmic and modeling structures need to be adjusted each time to account the specific sensor design features. The adjustment requires a level of knowledge of the sensor-device technological and structural features which is rarely achievable.

Another current method for mitigating the effects of crosstalk is by evaluating the sensor's signal/crosstalk cross-responsivity distribution using spot light stimulation. The evaluated crosstalk distribution is then used to adjust a sensor output signal, in order to correct the distorted raw data before further processing.

The S-cube system utilizes a confocal fiber tip placed immediately above the sensor surface with no optics. While the S-cube system provides an accuracy sufficient for the older Complementary Metal Oxide Semiconductor (CMOS) processes with relatively large pixel sizes, it does not provide the accuracy required by current CMOS processes. [See I. Shcherback, T. Danov, O. Yadid-Pecht, “A Comprehensive CMOS APS Crosstalk Study: Photoresponse Model, Technology and Design Trends”, IEEE Trans. on Elec. Dev., Volume 51, Number 12, pp. 2033-2041, December 2004; I. Shcherback, T. Danov, B. Belotserkovsky, O. Yadid-Pecht, “Point by Point Thorough Photoresponse Analysis of CMOS APS by means of our Unique Sub-micron Scanning System,” Proc. SPIE/IS&T Sym. on Electronic Imaging: Science and Technology, CA, USA, January 2004; and I. Shcherback, O. Yadid-Pecht, “CMOS APS Crosstalk Characterization Via a Unique Submicron Scanning System,” IEEE Trans. Electron Devices, Vol. 50, No. 9, pp. 1994-1997, September 2003.]

In U.S. Pat. No. 6,122,046 by Almogy, an optical inspection system for inspecting a substrate includes a light detector, a light source, a deflection system, an objective lens and an optical system. The light source produces an illuminating beam directed along a path to the substrate. The deflection system scans the illuminating beam on a scan line of the substrate. The objective lens focuses the illuminating beam on the substrate and collects light reflected therefrom. The collected beam is angularly wider than the illuminating beam. The optical system directs the collected light beam along a path at least partially different than the path of the illuminating beam and focuses the collected beam on the light detector.

In U.S. Pat. No. 5,563,409 by Dang, et al., an automated test system and method for infrared focal plane detector array which utilizes X-Y positioning of a focused laser spot scanning individual detector array elements. Focusing optics are mounted for computer controlled translation so that automatic control of lens position is achieved resulting in the focus of the spot onto a detector element. Once the spot is focused, the position of the lens remains fixed.

In U.S. Pat. No. 6,248,988 by Krantz a multispot scanning optical microscope image acquisition system features an array of multiple separate focused light spots illuminating the object and a corresponding array detector detecting light from the object for each separate spot. Scanning the relative positions of the array and object at a slight angle to the rows of the spots allows an entire field of the object to be successively illuminated and imaged in a swath of pixels. The scan speed and detector readout direction and speed are coordinated to provide precise registration of adjacent pixels despite delayed acquisition by the adjacent columns of light spots and detector elements. The detector elements are sized and spaced apart to minimize crosstalk for confocal imaging and the illuminating spots can likewise be apodized to minimize sidelobe noise.

### SUMMARY OF THE INVENTION

Embodiments presented below teach an apparatus and method capable of accurately focusing a light spot on individual pixels within an optical pixel array, so that the light spot does not illuminate pixels neighboring the current pixel of interest. The apparatus is capable of adjusting both the planar location of the light spot on the surface of the pixel array and the depth at which the light spot is focused. In some embodiments the light spot is at multiple wavelengths of interest. In other embodiments the light spot is at a single wavelength. In some embodiments the wavelength (or wavelengths) are selected in accordance with the current application.

As used herein, the terms “current pixel” and “pixel of interest” mean the pixel upon which the light spot is being focused in order to measure its response. As used herein the term “pixel array” means multiple pixels situated on a common substrate. The pixels may be arranged in any configuration, and are typically in a rectangular configuration. As used herein the term “light spot” means the area of light illuminating the pixel. As used herein the term “neighboring pixel” means a pixel within a specified distance from the current pixel. For example, a neighboring pixel may be a pixel immediately adjoining the current pixel or may be within a distance of two pixels from the current pixel. As used herein the term “image sensor” means any device which incorporates a pixel array, and provides image data derived from the pixel array output signal.

The sensor output is analyzed repeatedly while scanning the sensor pixels to obtain a control signal which is fed back to maintain accurate focus of the light spot during the progress of the scan. The embodiments below are suitable for a pixel array situated on a common substrate, and are applicable for both monochrome and color sensors, with or without a microlens array (MLA).

Maintaining the focus of the light spot within the pixel boundaries enables the precise measurement of the pixel array output signal, while illuminating each pixel individually in turn. This measurement data may be used to accurately determine signal/crosstalk cross-responsivity distribution amongst the sensor pixels. The signal/crosstalk cross-responsivity distribution may be represented in matrix form. The accurate crosstalk share may then be used to sharpen and enhance sensor resolution, improve color/tint separation and rendering for the image obtained from the sensor, in the terms of recovering the information “lost” by each pixel to its neighborhood pixels, or more precisely, smeared by crosstalk between the pixels in the array.

Some embodiments include two stages. In the first stage, the signal/crosstalk cross-responsivity distribution within the pixel array is precisely determined by scanning the pixel array while periodically adjusting the focus of the light spot to the photosensitive portion of the current pixel. In the second stage the precisely determined signal shares are rearranged for a captured image, so that the photocarriers captured by the “wrong” pixels are restored to the pixel they initially originated from. Except for the photocarriers lost to the bulk recombination and other factors, the rest of the collected photocharge is reoriented and the original image is reconstructed without additional signal loss.

According to an aspect of some embodiments of the present invention there is provided an apparatus for the measurement of optical sensor performance, wherein the optical sensor includes a plurality of pixels. The apparatus includes a light emitter, a focuser and a controller. The light emitter projects a light spot onto the sensor. The focuser focuses the light spot onto a specified portion of the sensor in accordance with a control signal. The controller analyzes an output signal of the optical sensor, and generates the control signal to an accuracy substantially confining the light spot to a single pixel, in accordance with the analysis. A per-pixel accuracy of measurement from the output signal is thus obtained.

According to some embodiments of the invention, each of the pixels includes a photosensitive layer, and the controller is operable to confine the focused light spot onto a respective photosensitive layer of the single pixel.

According to some embodiments of the invention, the focuser includes a positioner configured for positioning the light emitter to project the light spot onto a planar location upon the sensor specified by a planar portion of the control signal.

According to some embodiments of the invention, the positioner includes at least one piezoelectric element.

According to some embodiments of the invention, the focuser is configured for adjusting a focusing depth of the light spot in the pixel in accordance with a focus portion of the control signal.

According to some embodiments of the invention, the focuser includes: an optical lens and a distance adjuster. The distance adjuster is configured to provide a specified relative distance between the light emitter and the optical lens.

According to some embodiments of the invention, the distance adjuster includes a stepper motor and lead screw.

According to some embodiments of the invention, the light emitter includes an optical fiber.

According to some embodiments of the invention, the controller is configured to analyze an output level of the single pixel relative to output levels of neighboring pixels, and to generate a control signal designed to increase the relative output level.

According to some embodiments of the invention, the apparatus further includes a light splitter configured for providing light emitted by the light source in parallel to the light emitter and to a power meter.

According to some embodiments of the invention, the controller is further configured to control an intensity of the light spot in accordance with a measured power of the provided light.

According to some embodiments of the invention, the controller is operable to scan the light spot over a neighboring group of pixels, and to perform the analysis repeatedly so as to adjust the control signal during the course of the scan.

According to some embodiments of the invention, the apparatus further includes a crosstalk evaluator configured for analyzing output signals of the optical sensor to determine a signal/crosstalk cross-responsivity distribution between optical sensor pixels.

According to some embodiments of the invention, the apparatus further includes an image adjuster configured for adjust image data in accordance with, thereby to improve a precision of the image data.

According to some embodiments of the invention, the image adjuster is configured to calculate a weighted sum of a pixel's output level with the respective output levels of neighboring pixels, in accordance with the signal/crosstalk cross-responsivity distribution.

According to some embodiments of the invention, the apparatus further includes a sensor positioning unit configured for adjusting a position of the sensor.

According to an aspect of some embodiments of the present invention there is provided a method for measuring optical sensor performance, wherein the optical sensor includes a plurality of pixels. The method includes:

projecting a light beam from a light source;

focusing the light beam to form a light spot on a specified portion of the sensor;

analyzing an output signal of the optical sensor in response to the light spot; and

adjusting a focus of the light spot to an accuracy substantially confining the light spot to a single pixel, in accordance with the analyzing, thereby to provide a per-pixel accuracy of measurement from the output signal.

According to some embodiments of the invention, each of the pixels includes a photosensitive layer, and the adjusting a focus is to an accuracy confining the focused light spot onto a respective photosensitive layer of the single pixel.

According to some embodiments of the invention, adjusting a focus includes adjusting a planar location and a depth focus of the light spot upon the sensor.

According to some embodiments of the invention, the method further includes controlling an intensity of the light beam.

According to some embodiments of the invention, the method further includes splitting the light beam prior to the focusing, and determining the light beam intensity in accordance with a measured intensity of one of the split light beams.

According to some embodiments of the invention, the method further includes scanning the light spot over a plurality of pixels on the optical sensor, and determining a signal/crosstalk cross-responsivity distribution between the pixels in accordance with a resultant optical sensor output signal.

According to some embodiments of the invention, the method further includes adjusting image data in accordance with the determined signal/crosstalk cross-responsivity distribution.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A illustrates a laser beam expanding to neighboring pixels;

FIG. 1B illustrates a laser beam focused on a single pixel;

FIG. 2 is a simplified block diagram of an apparatus for the measurement of optical sensor performance, according to an embodiment of the present invention;

FIG. 3 is a simplified block diagram of a measurement system for an optical sensor, in accordance with an embodiment of the present invention;

FIG. 4 is a simplified illustration of an exemplary 3-D Scanning System;

FIG. 5 depicts a raster scanning principle;

FIGS. 6A and 6B illustrate a central pixel's first nearest neighborhood interactions, from and to the central pixel and its neighbors;

FIG. 7 is a simplified flowchart of a method for measuring optical sensor performance, in accordance with an embodiment of the present invention;

FIG. 8 shows a crosstalk-disturbed image obtained from raw optical sensor data;

FIG. 9 shows an image obtained after crosstalk compensation; and

FIG. 10 shows the difference between the images in FIGS. 8-9 (i.e. the crosstalk compensation value).

### DESCRIPTION OF SPECIFIC EMBODIMENTS OF THE INVENTION

The present invention, in some embodiments thereof, relates to the measurement of an optical sensor output signal by accurately focusing a light spot on the optical sensor, and, more particularly, but not exclusively, to the analysis of the measured optical sensor performance data for pixel crosstalk evaluation.

Embodiments presented herein describe the precise focusing of a light spot on individual pixels of an optical pixel array. The resulting pixel array output signal may be used for a highly-accurate determination of the cumulative sensor crosstalk (i.e., photonic and electronic) signal share distribution within the pixel and its surroundings.

Some current CMOS technologies enable the size of a single optical sensor pixel to be in the order of 1.3-2 micrometers. It is anticipated that in the future the pixel size will decrease to less than one micrometer. Therefore, in order to improve current and future imaging system performance it is desired that light spot projected onto a single pixel be focused to less than one micrometer (i.e. submicron measurement resolution is required).

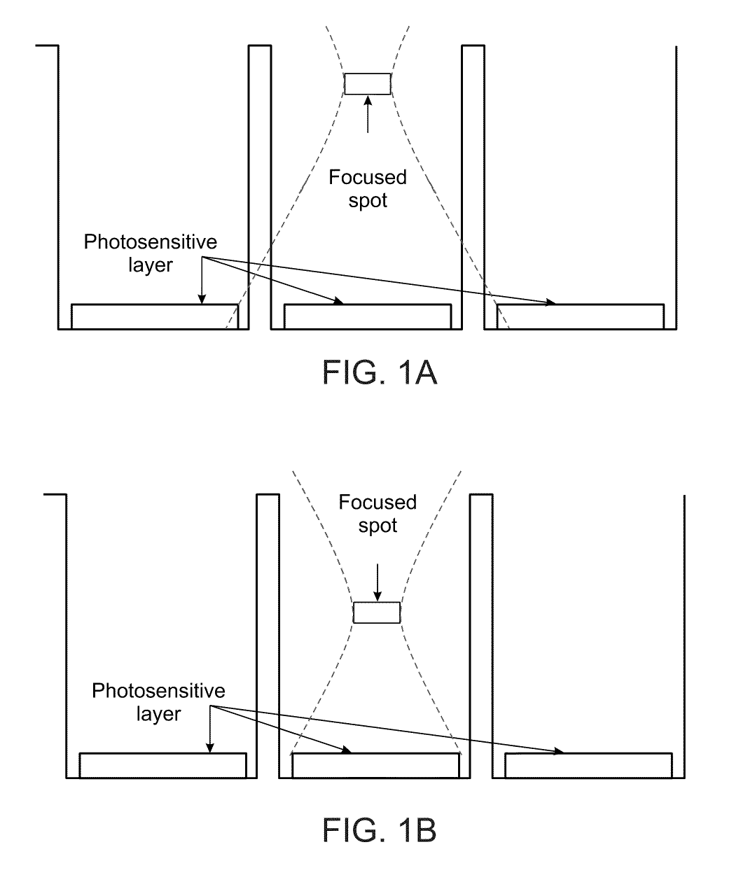

Moreover, in a CMOS-pixel layered structure the photosensitive region (also denoted herein the pixel's photosensitive layer) is typically located at the bottom of the pixel. (In modern CMOS technological processes the photosensitive layer is usually the layer next to the substrate.) This dictates a need to avoid light beam propagation through the pixel from expanding beyond the photosite boundaries, in order to avoid additional artificial crosstalk signal which might arise if the over-expanded light beam impinges onto the neighbor pixel's photosensitive region. FIGS. 1A-1B illustrate laser beam propagation within the pixel neighborhood, and show how proper focusing depth may prevent the light spot from expanding onto a neighboring photosensitive region.

Crosstalk in pixel arrays is considered one of the main sources of imager performance degradation (for both color and monochrome sensors), affecting image resolution and final picture quality (e.g., worse color rendering and lower picture contrast). Thorough and carefully directed sensor crosstalk compensation for a specific sensor design may yield improved effective resolution and overall sensor performance. The sensor-specific compensation should take into account the sensor design asymmetry and/or CFA and/or MLA occurrence.

The resolution of a sensor is the smallest change the sensor can detect in the quantity that it is measuring. The resolution quantifies how close lines can be to each other and still be visibly resolved (i.e. distinguished from one another). Line pairs are often used instead of lines, where a line pair is a pair of adjacent dark and light lines per unity length. Currently, the resolution of an image sensor is characterized by its absolute pixel count. In fact, the pixel count does not necessarily reflect the true resolution of the sensor, due to the global distortion occurring in each and every physical pixel. The global distortion is manifested in information leakage from this pixel to its surroundings or crosstalk. The crosstalk degrades the spatial resolution, such that the real effective imager resolution (i.e. the resolvable line pairs) might be much below the nominal resolution which is represented by the number of pixels in the array.

As used herein, the term “effective resolution” means the maximal quantity of the line pairs per unit length in an image, for which is it still possible to distinguish (i.e. resolve) each line (when contrasted with a monotone background).

Embodiments presented below provide accurately controllable three-dimensional (3-D) light focusing inside a particular pixel. In some embodiments the light spot may be focused through one or more of: transparent oxide layers, color filters and one or more microlenses. By avoiding the creation of the artificial additional crosstalk by beam expansion, an accurate measurement of the output signal of a pixel and its surroundings as a function of the light spot position may be obtained (i.e. precise two-dimensional responsivity map acquisition).

As used herein the responsivity map is the direct electronical result that is obtained via spot light stimulation of the image sensor. It constitutes the electrical reaction of each particular sensor/pixel region/point that was illuminated.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

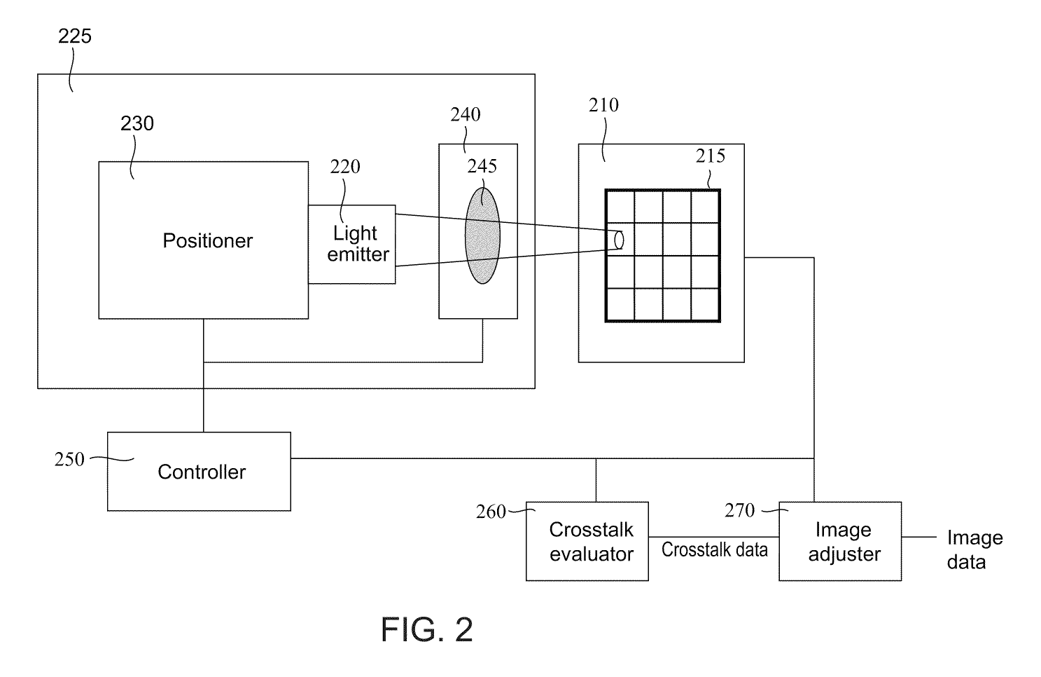

Reference is now made to FIG. 2, which is a simplified block diagram of an apparatus for the measurement of optical sensor performance, according to an embodiment of the present invention. The image sensor characterization apparatus focuses a light beam onto a specified portion of a single pixel. The term “specified portion” means that both the planar location and the depth of focus within the pixel are specified.

Optical sensor 210 includes multiple pixels 215, each of which contains a respective photosensitive layer. For exemplary purposes, the non-limiting embodiments described below are directed at an optical sensor whose multiple pixels are arranged in an array (denoted herein a “pixel array”), however the pixels may be arranged in other configurations.

Embodiments are possible for different types of pixels situated on a substrate, including CMOS pixels and Charge Coupled Device (CCD) pixels.

By adjusting both the planar location and the depth of focus of the light spot, the light spot focus may be located on the surface of the tested sample (suitable for non-transparent sensors) or somewhere inside the sensor volume (suitable for transparent sensors, e.g. CMOS imagers), or anywhere above or below the sample itself. The exact placement of the focused point is based on the application requirements.

In the present embodiment, the image sensor characterization apparatus includes light emitter 220, a focuser, and controller 250.

The image sensor characterization apparatus includes a lens-based optical system, (e.g. microscope lens, reverse lens expander, etc.). Embodiments are possible for different types of lens systems, such as a microscope objective or a reverse lens expander. The optical system should provide the required focusing accuracy for the particular wavelength(s) and application.

### Light Emitter

Light emitter 220 projects a light spot onto the sensor. Light emitter 220 includes a light source which emits light with the appropriate optical properties (e.g. the light beam wavelength and intensity). In some embodiments the light source is a monochrome source such as a laser, if the application requires wavelength distinction. In other embodiments the light source is comprised of multiple lasers which together produce monochrome light at multiple different wavelengths. Embodiments are possible for different wavelength ranges including the visible spectrum, the near-visible spectrum, and the near-infrared (NIR) spectrum.

Embodiments are possible for other types of light sources, such as an LED light source or a radiometric power supply (lamp) conjugated with a monochromator.

In some embodiments light emitter 220 includes an optical fiber, which conducts the light emitted by the light source to a different location. Thus the direction of the emitted light may be controlled by moving the optical fiber rather than the light source itself. The fit of the fiber (type, core size, modality, etc) and the optical system properties predetermine the focus point planar and movement dimensions, and consequently the required submicron spot scanning resolution. Note that the actual dimensions of the scanning spot may be around the diffraction limit for a particular wavelength used.

In further embodiments, additional optical elements, such as the beam splitter described below, are located in the path of the light beam emitted by the light source.

### Focuser

The focuser focuses the light spot projected by light emitter 220 onto a specified portion of the sensor in accordance with a control signal provided by controller 250. The control signal may be digital and/or analog, as required by the specific embodiment. The focuser serves to focus the light on a specified location on the surface of sensor 210 (denoted herein the “planar location”), and also to a specified focusing depth relative to the sensor substrate (denoted herein the “focusing depth”).

In some embodiments the focuser includes positioner 230 which adjusts the planar location of the light spot and distance adjuster 240 which adjusts the focusing depth.

Positioner 230 positions light emitter 220 to project the light spot onto a specified planar location upon sensor 210, as specified by a planar portion of the control signal. The light spot may be scanned across pixel array 215, as required to measure the sensor performance (e.g. crosstalk).

In some embodiments, positioner 230 is attached to an optical fiber which conducts light emitted by the light source. In order to direct the light to a particular location on the surface of sensor 210, positioner 230 points the optical fiber in the required direction.

In an exemplary embodiment, positioner 230 includes at least one piezoelectric element which is attached to the light fiber, as described in more detail below.

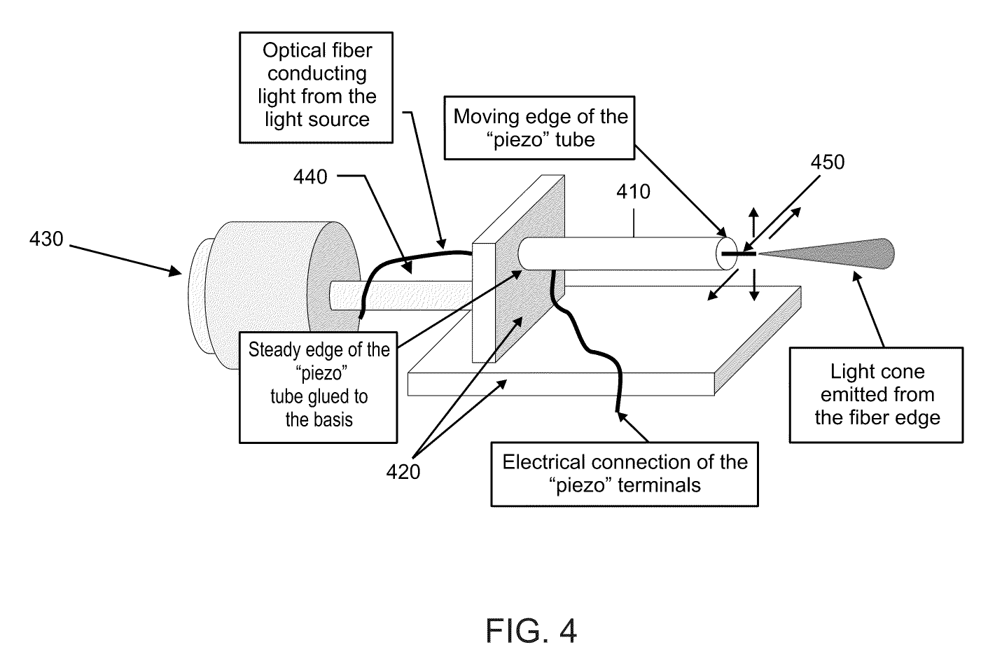

Distance adjuster 240 adjusts the relative distance between light emitter 220 and/or lens 245 to the distance required to obtain the focusing depth specified by a focus portion of the control signal. The relative distance may be obtained by adjusting the location(s) of light emitter 220 (e.g. optical fiber) and/or lens 245 and/or sensor 210. In some embodiments, distance adjuster 240 includes a stepper motor and lead screw, as shown in FIG. 4.

Note that in some embodiments adjusting the light spot planar location is alternately or additionally achieved in a different manner, for example by moving mirrors which reflect the emitted light and/or by moving the sensor under test.

In one embodiment the focuser includes a microscope with light emitter 220 positioned at a required distance from a microscope eye-piece. The focused light spot is located below the microscope objective, where regular samples for microscope inspection are usually placed. Movement of the emitting optical fiber edge and/or of the 3D stage on which sensor 210 is situated is directly translated to the movement of the focused light spot (with the corresponding magnification).

### Controller

Controller 250 analyzes the output of the optical sensor, and generates the control signal for the focuser in accordance with the analysis. The control signal is generated to an accuracy which substantially confines the light spot to a single pixel. The term “substantially confines” means that the light spot does not exceed the boundaries of the pixel to an extent which results in an output by neighboring pixels which exceeds the requirements of the current application. In some embodiments, is generated to an accuracy which substantially confines the light spot to the pixel's photosensitive layer. By confining the light spot to a single pixel (or to a portion of the pixel such as the pixel's photosensitive layer) the sensor output signal may be provided with a per-pixel accuracy of measurement.

In some embodiments the control signal includes a planar portion and a focus portion, which adjusts positioner 230 and distance adjuster 240 respectively.

In an exemplary embodiment, controller 250 directs the focuser to project the light spot onto an approximate location on the sensor, analyzes the output level of the pixel of interest relative to output levels of neighboring pixels, and adjusts the control signal in order to increase the relative output level. The process may be repeated multiple times, in order to improve the precision of the focusing.

As discussed below, during the sensor measurement process, controller 250 may scan the light spot over all or a portion of the pixel array. In some embodiments, controller 250 adjusts the control signal during the course of the scan, by performing the analysis repeatedly during the scan. For example, the light spot focus may be adjusted for each individual pixel being scanned.

### Exemplary Measurement System

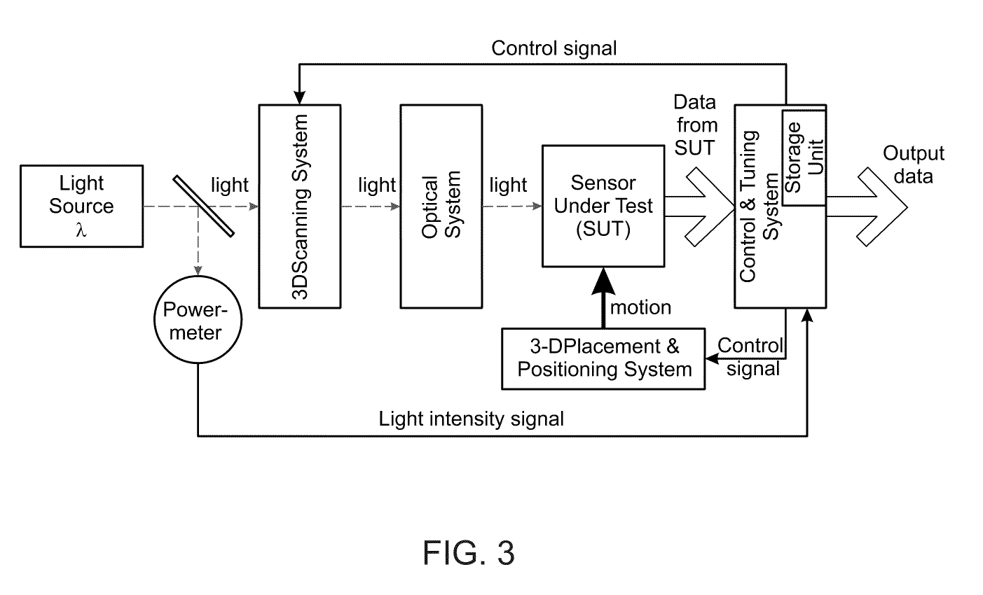

Reference is now made to FIG. 3, which is a simplified block diagram of a measurement system for an optical sensor, in accordance with an exemplary embodiment of the present invention. The present embodiment includes a 3-D Placement and Positioning System, a 3-D Scanning System, an optical system, and a control and tuning system. The control and tuning system performs automatic/manual correlation between the signal from the sensor and control, monitoring fine controllable focus at particular depth (during the scan), which ensure the light beam propagation through the pixel without unwanted beam expansion (beyond the photosite boundaries).

In the present embodiment, light emitted by a light source enters into a beam splitter. One of the beam splitter's outputs is coupled to an optical fiber, which in turn conducts the light to the 3-D Scanning System. The 3-D Scanning System directs the light towards an optical system. In an exemplary embodiment, the optical system includes a lens located in a microscope eyepiece with adjustable magnification, which increases the precision of the light spot focus. An extremely high precision Z-axis vertical resolution (in the order of nanometers) may be obtained, which is essential for fine spot focusing within the sensor.

The other beam splitter output is connected to a power meter which measures the beam intensity. The measured beam intensity is processed by the control and tuning system, and, in correlation with the readout from the sensor under test, is used for controlling the light source intensity and/or scanning and/or focusing control. Thus the light spot intensity on the sensor may be controlled in real-time during the measurement process.

FIG. 4 is a simplified illustration of an exemplary 3-D Scanning System. The 3-D Scanning System includes a piezoelectric element 410 partially attached to a base 420. Base 420 is connected to stepper motor 430 and leading screw 440, which provide high precision Z-axis vertical movement.

The piezoelectric element is also attached to the optical fiber 450 which conducts the light from the light source. The edge of optical fiber 450 emits the light into free space in the direction of an optical system (not shown).

Piezoelectric element 410 provides X-Y planar movement. Application of an electrical signal to the terminals of piezoelectric element 410 causes its deformation. This causes the part of the piezoelectric element attached to optical fiber 450 to move in space relative to the base, which in turn causes a change in the direction of the light emitted from the fiber.

In one embodiment piezoelectric element 450 is in a tube form, with four isolated terminals on the outer surface and one terminal covering the inner surface of the tube. The outer terminals are shaped as stripes in the tube axis direction. One edge of the tube is attached to moving base 420, and the second edge of the tube is attached to optical fiber 450. Applying a differential electrical signal to the outer terminals (relative to the inner terminal which provides a reference) causes the tube to bend. This moves the edge of optical fiber 450 by an amount precisely determined by the applied signals. The four outer terminals provide an opportunity to control the movement of the optical fiber edge along two orthogonal directions separately and independently.

In the present embodiment of the 3-D Scanning System, scanning is performed by applying two differential voltages to the piezoelectric element tube in order to control two orthogonal axes of the scan. Application of the two voltages (denoted X and Y voltages) in a certain order can create ordered movement of the light cone in two orthogonal axes, X and Y, so that a desired scanning area may be covered.

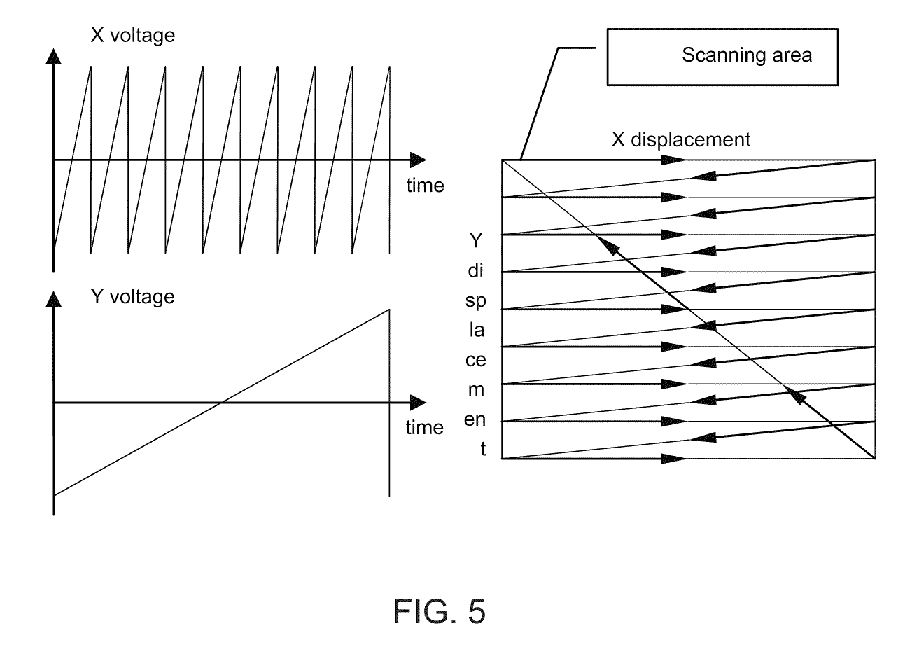

In one embodiment a raster scanning principle is used, as depicted in FIG. 5. The raster scanning utilizes a sawtooth waveform for both X and Y voltages, where the X voltage has a higher frequency than the Y voltage. The raster scanning principle is not the only one possible. Any type of scanning order may be obtained by applying appropriate voltages to X and Y terminals of the piezoelectric element.

The advantages of using a piezoelectric element are the high linearity and movement precision of the piezoelectric element, which ensures both high precision horizontal scanning and high precision vertical focusing. Note that the non-linearity and hysteresis of the piezoelectric element are deterministic phenomena, and may be compensated for by applying correction voltages.

Some embodiments include a sensor positioning unit which adjusts the position of the sensor under test. In the system of FIG. 3, the sensor positioning unit is denoted the “3-D Placement and Positioning System”. The 3-D Placement and Positioning System is used as a physical mainstay for the sensor under test and for the printed circuit board upon which the sensor is located. The 3-D Placement and Positioning System includes three independently controllable moving stages that determine the movement/scan area boundaries, and provide coarse static initial focusing and high precision 3-D positioning.

Referring again to FIG. 3, the measurement system also includes a Control and Tuning System. The Control and Tuning System provides the control signals required to direct and focus the light spot on the sensor under test in the desired scanning order, and to process and store both the electrical signal obtained from the sensor under test and the incoming light intensity signal. Fine focusing is determined by the control signals sent by the Control and Tuning System to both the 3-D Placement & Positioning and the 3-D Scanning Systems.

Control and Tuning System also permits performing manual measurements by manually inserting desirable sets of coordinates. The 3-D Scanning System may then perform the measurements only at these manually-entered points of the pixel array. In other words, it is possible to obtain the output signal only for pixels of interest in the array.

Based on an analysis of the sensor output, the Control and Tuning System controls and manages the scanning process. At each scanning point, the sensor output signal is monitored, and its consistency with the fine focusing requirements is determined. The Control and Tuning System processes the signal from the sensor in real time, checks its correlation with the light source signal, and generates the control signals required to maintain the focusing (e.g., the spot size and the focusing depth), assuring measurement precision. The correlation between the pixel output signals is used for generating control signals that are fed back to drive the 3-D Placement & Positioning and the 3-D Scanning Systems. The Control and Tuning System may employ image restoration algorithms that utilize sensor optical parameters which are determined from the sensor measurement process (such as a light spot intensity profile for each wavelength).

In one embodiment, the Control and Tuning System synchronizes the scanning process with a built-in storage unit. The Control and Tuning System supplies the light spot coordinates to the storage unit, so that the scanned image may be rebuilt from separate samples. The storage unit, on the other hand, has a finite response time to successively store the received samples, therefore, may inform the Control and Tuning System whether or not it is ready to accept the next sample sensor output data. Such bidirectional synchronization between the control and the storage unit can be accomplished by electronic means, with or without software implementation.

In an embodiment, the Control and Tuning System is a personal computer equipped with digital I/O interface cards (PCI cards and/or frame grabber) with custom algorithms/drivers/software. The algorithms may serve for choosing the resolution and scan speed (and possibly other parameters) of the scanning process. The Control and Tuning System reads out and processes the signal from the optical sensor under test, and outputs the signal/crosstalk cross-responsivity distribution in the appropriate format. The Control and Tuning System may include algorithms for displaying and storing the obtained images, and possibly for increasing the image resolution.

In another embodiment, the Control and Tuning System includes multiple software driven devices which are coordinated by a controlling utility such as a personal computer.

### Responsivity Map and Cumulative Crosstalk Acquisition

In some embodiments, the measurement apparatus includes a crosstalk evaluator which analyzes output signals from an optical sensor under test to determine crosstalk between pixels (260 in FIG. 2). In some embodiments the crosstalk evaluator uses sensor modeling in addition to the output signal analysis, in order to further improve the accuracy of the crosstalk evaluation.

Further embodiments include an image adjuster which adjusts image data in accordance with the signal/crosstalk cross-responsivity distribution (270 in FIG. 2). Since the origin of each contributive share to the pixel output is known with high precision, the output signal of each pixel may be adjusted to eliminate the contribution of neighboring pixels and to compensate for charge which the pixel lost to neighboring pixels. For example, the image adjuster may calculate a weighted sum of each pixel's output level with the output levels of neighboring pixels. An exemplary embodiment is described below.

The changes/rearrangement performed on raw sensor data does not affect the subsequent image processing chain. However, the overall sensor performance and the final image quality may be improved, since the image is generated from “better” raw data. In the exemplary embodiment described below, the raw data output by the sensor is improved by rearranging signal shares between the pixels, based on the signal/crosstalk cross-responsivity distribution determined by the crosstalk evaluator. The final image quality may be improved (e.g., finer resolution, greater color separation, color rendering, tint and contrast enhancement), without introducing any changes into the algorithms performed to generate the image from the sensor output data.

As used herein the signal/crosstalk cross-responsivity distribution is a derivative result obtained by calculation from the responsivity map. The signal/crosstalk cross-responsivity distribution represents the overall signal distribution of the pixel itself (integrated over the entire pixel area) and the pixel's surroundings (i.e., the crosstalk).

The following describes an exemplary embodiment for crosstalk share evaluation, which may be implemented by an embodiment of the measurement apparatus described above.

The photosensitive media (i.e. sensor) is scanned to explore its spatial responsivity distribution. Each scanned pixel converts the incident light into an electric signal (either voltage or current or charge). The obtained signal is output from the pixel array (or from the device containing the pixel array, such as an imager) in raw format (i.e. without further processing). During the scanning operation the incident light intensity is controlled and measured, and the ambient temperature is possibly controlled as well.

The electrical output signal obtained by illuminating a portion of a pixel is integrated over the whole pixel area. The sensor output signal produced is equivalent to the signal obtained for the same total radiant power absorbed by the detector but averaged over the entire detector area, and represents the overall system impulse response or point spread function.

A point-by-point quantitative analysis of the contributions to the total output signal from each particular region of the pixel itself and its neighboring pixels is made (e.g., the “incoming” and “outgoing” cumulative crosstalk shares are inherently measured). Three-by-three or larger pixel sub-arrays may be considered. This analysis provides a two-dimensional (2-D) cross-responsivity map (i.e. distribution) of the scanned area as a function of the light spot position and full Point Spread Function (PSF) extraction. The PSF represents the overall system impulse response or spread function for the smallest element recordable in the image scene. The resulting 2-D cross-responsivity map includes the pixel response and cumulative photonic crosstalk influences (which may be dependant on the specific layer structure and/or MLA occurrence). Chromatic and electronic crosstalk are inherently considered.

The present embodiment provides a high spatial frequency without causing additional disturbing optical effects. The signal/crosstalk cross-responsivity distribution represents the response of each pixel in the neighborhood, that is the contribution that each pixel receives/returns from/to its neighbors as a result of the central pixel irradiation by unity incident power.

The signal/crosstalk cross-responsivity distribution may alternately be defined as the normalized ratio of the neighbor pixel contribution detected in the current pixel to its own maximum value (integrated over the entire pixel area).

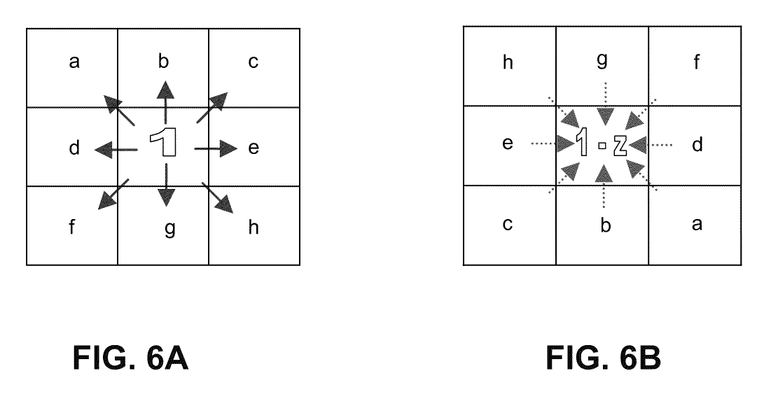

Without loss of generality, and for any monochrome or color sensor, consider the first nearest neighborhood interactions (see FIGS. 6A-6B). This approach may be adapted to account for the interaction of any neighborhood extension. For example, the contribution second, third, and even more distant neighboring pixels contribution may be taken into consideration.

For the sake of simplicity the general crosstalk neighborhood (i.e., signal/crosstalk cross-responsivity distribution) is presented here by a signal/crosstalk cross-responsivity distribution matrix, where a, b, c, d, e, f, g, h are the coefficients representing the crosstalk shares obtained by the cross-responsivity determination. In the present exemplary embodiment, scanning is performed with submicron light spot resolution, which enables distinguishing the exact signal/crosstalk cross-responsivity distribution between the neighbors. Each of the incoming and the outgoing signal and crosstalk fractions relative to the central pixel's maximum signal is determined (the central pixel's maximum signal is considered unity). The solid arrows in FIG. 6A represent the outgoing “donor” interactions, that is the contribution of the central pixel to its neighbors. The dashed arrows in FIG. 6B represent the incoming “collection” interactions, that is the contribution to the central pixel from each of the neighbors.

The present method takes into account the general image sensor crosstalk asymmetry which may be caused by design asymmetry (including CFA in color sensors) [see I. Shcherback, O. Yadid-Pecht, “CMOS APS Crosstalk Characterization Via a Unique Submicron Scanning System,” IEEE Trans. Electron Devices, Vol. 50, No. 9, pp. 1994-1997, September 2003]. Asymmetry in crosstalk interaction between neighboring pixels means that the signal (or contribution) that a pixel receives from each of its neighbor is different. Moreover, the share that a pixel receives from a specific neighbor is usually not equal to the share it returns to the same specific neighbor. For example, the middle pixel in the 3×3 pixel array of FIGS. 6B and 6B collects a fraction “d” from its left-hand nearest neighbor and returns a different fraction “e” of its own signal. “1-z” represents the middle pixel's total loss to its surroundings. These losses also can be estimated by measurement, by illuminating the middle pixel and sampling its neighboring pixels.

Note that the present embodiment does not consider the crosstalk sources, but rather determines the signal collection occurring within the pixel neighborhood.

Based on the above coefficients, and representing the coefficients as specific noise parameters, the inverse de-noising problem may be generally solved. The de-noising algorithm is matched to the specific sensor design via the signal/crosstalk cross-responsivity distribution characteristic to that design, and compensates for the crosstalk distortion in the sensor. In essence, the photocarriers captured by the “wrong” pixels are “restored” to the pixel they initially originated from, without signal loss.

Crosstalk compensation results in improved sensor effective resolution via signal blur minimization, and enhanced overall sensor performance (e.g., contrast enhancement, color tint improvement, etc.). In a color optical sensor, rearrangement of the crosstalk shares restores the color fractions jumbled by crosstalk to their origins, thus correcting color separation and rendering. The final image color disparity is reduced and color tint (after color interpolation) is improved.

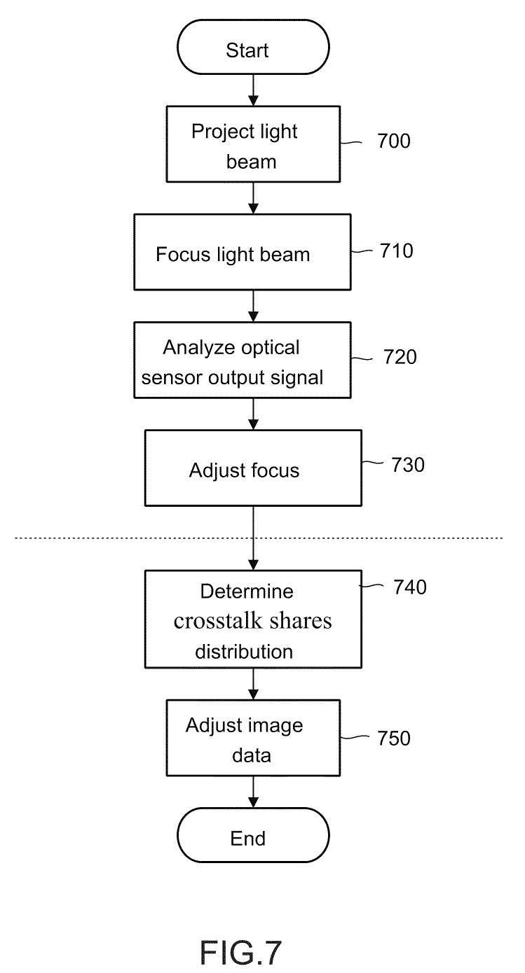

Reference is now made to FIG. 7, which is a simplified flowchart of a method for measuring optical sensor performance, in accordance with an embodiment of the present invention.

In 700 a light beam is projected from a light source. In 710 the light beam is focused to form a light spot on a specified portion of the sensor. In 720 an output signal obtained from the optical sensor in response to the light spot is analyzed. In 730 the focus of the light spot is adjusted to an accuracy substantially confining the light spot to a single pixel, in accordance with the analysis. In some embodiments the focus is adjusted to an accuracy which confines the focused light spot to the pixel's photosensitive layer. As above, confining the light spot to a single pixel (or to the pixels photosensitive layer) provides a per-pixel accuracy of measurement.

In an embodiment, adjusting the light spot focus includes adjusting the planar location and the depth focus of the light spot upon the sensor. Some embodiments further include controlling the intensity of the light beam. The intensity may be controlled by splitting the light emitted from the source. One of the split beams is focused on the optical sensor, and the measured intensity of the second split beam is used to determine the intensity of the light source (and consequently of the light spot focused upon the optical sensor).

The method may further include scanning the light spot over a plurality of pixels on the optical sensor, and determining a signal/crosstalk cross-responsivity distribution between the pixels in accordance with a resultant optical sensor output signal (740 of FIG. 7). In some embodiments determining the signal/crosstalk cross-responsivity distribution is performed using a sensor model in conjunction with an analysis of sensor output signals.

The method may further include adjusting image data in accordance with the determined signal/crosstalk cross-responsivity distribution (750 of FIG. 7). The image data is obtained from an image sensor having the same or a similar design to that of the measured optical sensor used to determine the crosstalk shares. Due to the high accuracy of the optical sensor measurement data, a highly-precise signal/crosstalk responsivity distribution is obtained. The origin of each contributive share to the pixel output is determined, and may be compensated for in the raw sensor output data prior to performing image processing.

In some embodiments the pixel's output signal is adjusted by weighting the output signals of the pixel of interest and its neighboring pixels based on the signal/crosstalk cross-responsivity distribution. The adjustment results in improved image quality (e.g. effective resolution, color/tint rendering). The improvement in image quality is a direct result of the high precision of the signal/crosstalk distribution measurement, which is made possible by the per-pixel accuracy of measurement obtained by the embodiments described herein.

In summary, the abovedescribed approach, which is performed for a specific monochrome or color sensor design, includes the following main stages:
i) Accurately scanning an optical sensor with a light spot focused on each pixel, without expanding into neighboring pixels.
ii) Precise determination of the sensor-specific signal/crosstalk cross-responsivity distribution between each pixel and its neighboring pixels. In an exemplary embodiment the cumulative crosstalk shares (e.g., photonic and electronic) are determined by direct cross-responsivity measurements by a image sensor characterization apparatus.
iii) Crosstalk compensation based on the precisely determined signal shares, which are mathematically restored to the pixel they originated from. The original image is reconstructed without signal loss. Note that for a color sensor several signal/crosstalk cross-responsivity distributions may be determined, representing the signal/crosstalk shares ratio around each CFA pattern representative.

In summary, real-time electronic crosstalk analysis and compensation may reduce crosstalk effects for an optical sensor output signal, inherently improving the effective sensor resolution as well as its overall performance and picture quality (e.g., color separation and rendering, picture contrast, tint, etc). A measurement apparatus is described above, which enables focusing a light spot at a specified planar location and focusing depth upon the sensor with sub-micron accuracy. Highly-accurate sensor output signal data may thus be obtained for analysis, for the precise determination of the crosstalk share signal/crosstalk cross-responsivity distribution amongst the sensor pixels.

The embodiments described herein provide cumulative imager crosstalk compensation for a sensor containing multiple pixels situated on a common substrate. Any neighborhood extension may be considered. The signals are rearranged to their origin in accordance with the determined crosstalk share cross-responsivity shares distribution, without signal loss.

It is expected that during the life of a patent maturing from this application many relevant optical sensors, pixels, imagers, lenses, and crosstalk share evaluation algorithms will be developed and the scope of the corresponding terms is intended to include all such new technologies a priori.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find calculated support in the following examples.

### EXAMPLES

Reference is now made to the following examples, which together with the above descriptions illustrate some embodiments of the invention in a non-limiting fashion.

The abovedescribed embodiment for crosstalk compensation was verified using a commercial CMOS Image Sensor (CIS) camera. A CIS is a CMOS integrated circuit used to convert a viewed image into a digitally recorded picture. A CIS, composed of an array of millions of cells (i.e. pixels), is the core of most current digital cameras.

The precise cumulative (optical+electronic) crosstalk was obtained using a image sensor characterization apparatus with submicron spot resolution. The focusing depth was controlled during the scan process. The light source emitted light with three different wavelengths covering the visible spectrum (632 nm, 514 nm, and 454 nm).

In the exemplary embodiment described herein, the focused light spot location and size were both obtained with an accuracy of on the order of tens of nanometers. It is anticipated that other embodiments may obtain an accuracy on the order of single nanometers or less.

Table 1 shows signal/crosstalk cross-responsivity distribution coefficients obtained for the CIS, based on the above-described Responsivity Map and Cumulative Crosstalk Acquisition technique. The signal/crosstalk cross-responsivity distribution was determined for each of the three different wavelengths. The values in the table represent the percentage of the maximum signal obtained in the investigated central pixel.

TABLE 1

| Red λ = 638 nm | | | Green λ = 514 nm | | | Blue λ = 484 nm | | |
|---|---|---|---|---|---|---|---|---|
| Upper left | Upper | Upper | Upper left | Upper | Upper | Upper left | Upper | Upper |
| neighbor | neighbor | right | neighbor | neighbor | right | neighbor | neighbor | right |
| 2.5733% | 5.3869% | neighbor | 1.8263% | 4.0991% | neighbor | 0.70927% | 2.4513% | neighbor |
| | | 0.5296% | | | 0.46345% | | | 0.19794% |
| Left | Pixel | Right | Left | Pixel | Right | Left | Pixel | Right |
| neighbor | investigated | neighbor | neighbor | investigated | neighbor | neighbor | investigated | neighbor |
| 9.1677% | 100% | 4.5106% | 6.9582% | 100% | 2.949% | 5.6328% | 100% | 2.553% |
| Lower left | Lower | Lower | Lower | Lower | Lower | Lower | Lower | Lower |
| neighbor | neighbor | right | left | neighbor | right | left | neighbor | right |
| 0.81091% | 11.766% | neighbor | neighbor | 10.439% | neighbor | neighbor | 7.1825% | neighbor |
| | | 0.60957% | 0.55962% | | 0.36673% | 0.48253% | | 0.35084% |

For the sake of simplicity, a standard Fourier-domain based deconvolution technique was used for undistorted image reconstruction. Note that any algorithmic solution for crosstalk compensation may be used once the crosstalk parameters matching the specific sensor are obtained.

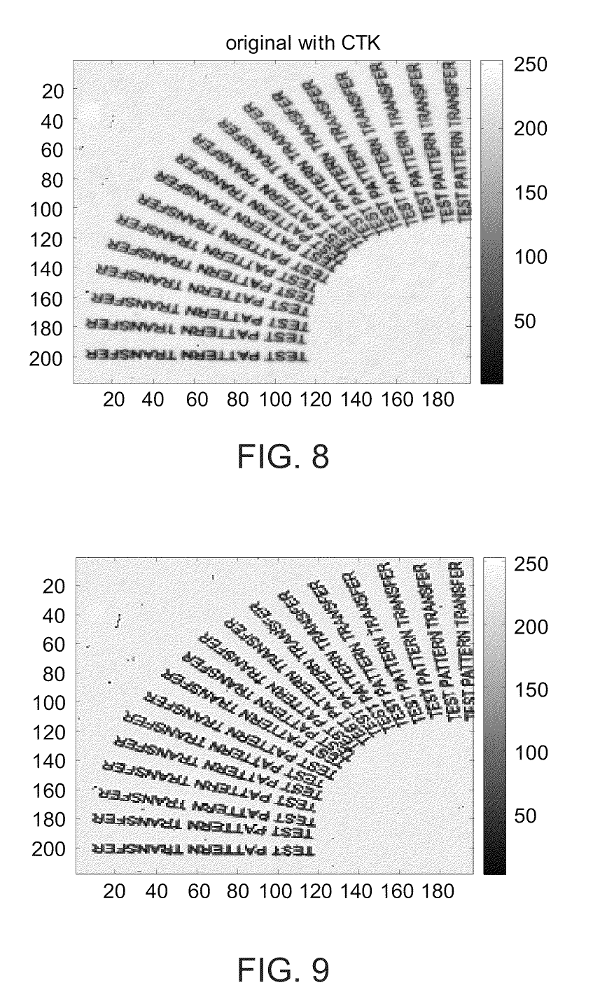

FIGS. 8-10 illustrate the image enhancement obtained in the present example. FIG. 8 shows the crosstalk-disturbed “real” picture obtained from the raw optical sensor data. It is clear from FIG. 8 that the image is smeared and that the camera resolution is damaged by crosstalk.

FIG. 9 shows the image obtained after crosstalk compensation. The image sharpness is improved. Details that are almost undistinguishable in the original picture (FIG. 8) are resolvable after the crosstalk is reduced.

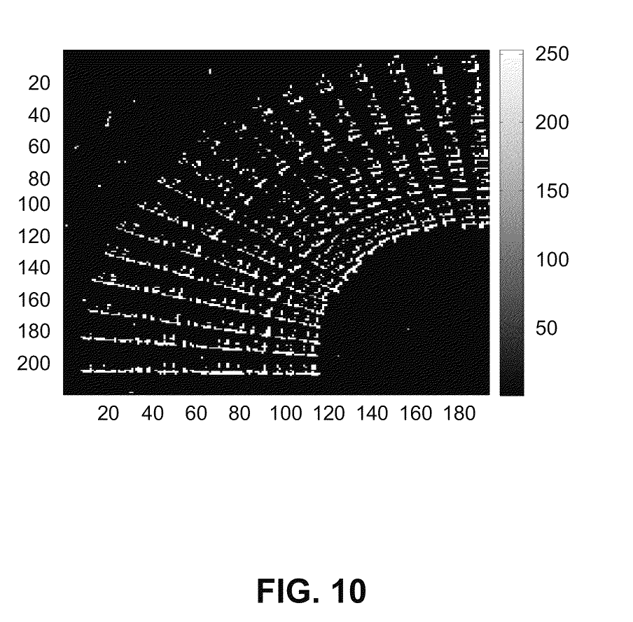

FIG. 10 shows the difference between the images in FIGS. 8-9 (i.e. the crosstalk compensation value). The main difference between the images is concentrated around the text, that is in the region where the camera resolution is most damaged by crosstalk in the relatively high spatial frequencies range.

The reduced crosstalk results in appreciable resolution and contrast improvements (e.g., 20% and 12% respectively). Color separation, rendering and overall image quality are improved as well.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An apparatus for the measurement of optical sensor performance, wherein said optical sensor comprises a plurality of pixels, comprising:
a light emitter, configured for projecting a light spot onto said sensor;
a focuser associated with said light emitter, configured for focusing said light spot onto a specified portion of said sensor in accordance with a control signal; and
a controller associated with said focuser, configured for analyzing an output signal of said optical sensor and for generating, in accordance with said analysis, said control signal to an accuracy substantially confining said light spot to a single pixel, thereby to provide a per-pixel accuracy of measurement from said output signal.

2. An apparatus according to claim 1, wherein each of said pixels comprises a photosensitive layer, and wherein said controller is operable to confine said focused light spot onto a respective photosensitive layer of said single pixel.

3. An apparatus according to claim 1, wherein said focuser comprises a positioner configured for positioning said light emitter to project said light spot onto a planar location upon said sensor specified by a planar portion of said control signal.

4. An apparatus according to claim 3, wherein said positioner comprises at least one piezoelectric element.

5. An apparatus according to claim 1, wherein said focuser is configured for adjusting a focusing depth of said light spot in said pixel in accordance with a focus portion of said control signal.

6. An apparatus according to claim 1, wherein said focuser comprises:
an optical lens; and
a distance adjuster, configured for providing a specified relative distance between said light emitter and said optical lens.

7. An apparatus according to claim 6, wherein said distance adjuster comprises a stepper motor and lead screw.

8. An apparatus according to claim 1, wherein said light emitter comprises an optical fiber.

9. An apparatus according to claim 1, wherein said controller is configured to analyze an output level of said single pixel relative to output levels of neighboring pixels, and to generate a control signal designed to increase said relative output level.

10. An apparatus according to claim 1, further comprising a light splitter configured for providing light emitted by said light source in parallel to said light emitter and to a power meter.

11. An apparatus according to claim 10, and wherein said controller is further configured to control an intensity of said light spot in accordance with a measured power of said provided light.

12. An apparatus according to claim 1, wherein said controller is operable to scan said light spot over a neighboring group of pixels, and to perform said analysis repeatedly so as to adjust said control signal during the course of said scan.

13. An apparatus according to claim 1, further comprising a crosstalk evaluator configured for analyzing output signals of said optical sensor to determine a signal/crosstalk cross-responsivity distribution between optical sensor pixels.

14. An apparatus according to claim 13, further comprising an image adjuster configured for adjust image data in accordance with, thereby to improve a precision of said image data.

15. An apparatus according to claim 14, wherein said image adjuster is configured to calculate a weighted sum of a pixel's output level with the respective output levels of neighboring pixels, in accordance with said signal/crosstalk cross-responsivity distribution.

16. An apparatus according to claim 1, further comprising a sensor positioning unit configured for adjusting a position of said sensor.

17. A method for measuring optical sensor performance, wherein said optical sensor comprises a plurality of pixels, said method comprising:
projecting a light beam from a light source;
focusing said light beam to form a light spot on a specified portion of said sensor;
analyzing an output signal of said optical sensor in response to said light spot; and
adjusting a focus of said light spot to an accuracy substantially confining said light spot to a single pixel, in accordance with said analyzing, thereby to provide a per-pixel accuracy of measurement from said output signal.

18. A method according to claim 17, wherein each of said pixels comprises a photosensitive layer, and wherein said adjusting a focus is to an accuracy confining said focused light spot onto a respective photosensitive layer of said single pixel.

19. A method according to claim 17, wherein said adjusting a focus comprises adjusting a planar location and a depth focus of said light spot upon said sensor.

20. A method according to claim 17, further comprising controlling an intensity of said light beam.

21. A method according to claim 20, further comprising splitting said light beam prior to said focusing, and determining said light beam intensity in accordance with a measured intensity of one of said split light beams.

22. A method according to claim 17, further comprising scanning said light spot over a plurality of pixels on said optical sensor, and determining a signal/crosstalk cross-responsivity distribution between said pixels in accordance with a resultant optical sensor output signal.

23. A method according to claim 22, further comprising adjusting image data in accordance with said determined signal/crosstalk cross-responsivity distribution.
